(19) United States
(12) Patent Application Publication
(10) Pub. No.: US 2006/0039338 A1
(43) Pub. Date: Feb. 23, 2006

(54) Integration of a wireless wide-area network (WAN) data terminal with a network processor for interfacing with local-area network (LAN) nodes

(76) Inventors: Mike Kwon, San Diego, CA (US); David Kim, San Diego, CA (US); Henry Kim, San Diego, CA (US); Sidney Park, San Diego, CA (US); James Kim, San Diego, CA (US); Peter You, San Diego, CA (US); Ethan Kim, San Diego, CA (US)

Correspondence Address: FROMMER LAWRENCE & HAUG, 745 FIFTH AVENUE- 10TH FL., NEW YORK, NY, 10151, US

(21) Appl. No.: 11/206,961

(22) Filed: Aug. 18, 2005

Related U.S. Application Data
(60) Provisional application No. 60/602,911, filed on Aug. 18, 2004.

(51) Int. Cl. H04B 7/00; H04Q 7/24

(52) U.S. Cl. 370/338; 370/310.1

(57) ABSTRACT

A wireless data terminal apparatus, comprising: a wireless wide-area network (WAN) data terminal configured to provide data communication over a wireless wide-area telecommunication network, the wireless WAN data terminal including at least a data processor and an RF section; and a network processing module configured to provide access to a local-area network (LAN), the network processing module providing multi-port switch functionality to allow connection of the wireless WAN data terminal to a plurality of LAN devices coupled to the LAN.

### CROSS-REFERENCE TO RELATED APPLICATIONS

This application claims the benefit of priority of co-pending U.S. Provisional Patent Application Ser. No. 60/602,911 entitled “Integration of Wireless Data Terminal with LAN Devices”, filed Aug. 18, 2004. Benefit of priority of the filing date of Aug. 18, 2004 is hereby claimed, and the disclosure of the Provisional Patent Application is hereby incorporated by reference.

### BACKGROUND

Wireless data terminals manage and control data communication over communication channels in wireless wide-area networks (WAN) such as a cellular network. Thus, a wireless data terminal that manages and controls data communication over communication channels in a cellular network is referred to as a cellular wireless data terminal.

The cellular wireless data terminal typically provides interfaces for connecting to a host computing device, such as a desktop or laptop computer, using Personal Computer Memory Card International Association (PCMCIA) card, Serial, or USB connection. However, PCMCIA, Serial, and USB connections are based on a host-to-device architecture, which allows only one host computing device to be connected to the wireless data terminal.

### SUMMARY

Embodiments of the present invention provide systems, methods, and apparatus for integrating a wireless wide-area network (WAN) data terminal with a network processing module to enable interfacing with a plurality of local-area network (LAN) devices.

In one implementation, a wireless data terminal apparatus is disclosed. The wireless data terminal apparatus, includes: a wireless wide-area network (WAN) data terminal configured to provide data communication over a wireless wide-area telecommunication network, the wireless WAN data terminal including at least a data processor and an RF section; and a network processing module configured to provide access to a local-area network (LAN), the network processing module providing multi-port switch functionality to allow connection of the wireless WAN data terminal to a plurality of LAN devices coupled to the LAN.

In another implementation, a system is disclosed. The system comprises: a local-area network (LAN) configured to network a plurality of nodes within a predefined distance of each other; a wireless wide-area network (WAN) configured to provide a communication network for a plurality of wireless WAN data terminals; and a wireless WAN data terminal apparatus operating to provide communication over the wireless WAN to the plurality of nodes in the LAN, the wireless WAN data terminal apparatus comprising: a wireless WAN data terminal configured to provide data communication over a wireless wide-area telecommunication network, the wireless WAN data terminal including at least a data processor and an RF section; and a network processing module configured to provide access to a local-area network (LAN), the network processing module providing multi-port switch functionality to allow connection of the wireless WAN data terminal to a plurality of LAN devices coupled to the LAN.

In another implementation, a method is disclosed. The method includes: configuring a wireless wide-area network (WAN) data terminal to provide data communication over a wireless wide-area telecommunication network, the wireless WAN data terminal including at least a data processor and an RF section; and configuring a network processing module to provide access to a local-area network (LAN), the network processing module providing multi-port switch functionality to allow connection of the wireless WAN data terminal to a plurality of LAN devices coupled to the LAN.

### BRIEF DESCRIPTION OF THE DRAWINGS

FIG. 1 illustrates one implementation of an integrated wireless data terminal device configured to provide interface between a wireless wide-area network (WAN) data terminal and a plurality of local-area network (LAN) devices.

FIG. 2 illustrates another implementation of an integrated wireless data terminal device.

### DETAILED DESCRIPTION

Embodiments of the present invention provide systems, methods, and apparatus for integrating a wireless wide-area network (WAN) data terminal with a network processing module to enable interfacing with a plurality of local-area network (LAN) devices. Typically, a local-area network is a network of nodes (e.g., computers) that are in the same general physical location, usually within a building or a campus.

The term “wireless WAN data terminal” as used in this disclosure refers to a telecommunication device that provides data communication over a wireless wide-area telecommunication network. Typically, the wireless WAN data terminal is configured as a plug-in device (e.g., a broadband WAN modem) for a laptop computer providing wireless communication over a wide-area network such as a cellular network. Thus, in one example, the wireless WAN data terminal may provide a high-speed Internet access in an area where there is no access to the Internet through a cable line or a public telephone line.

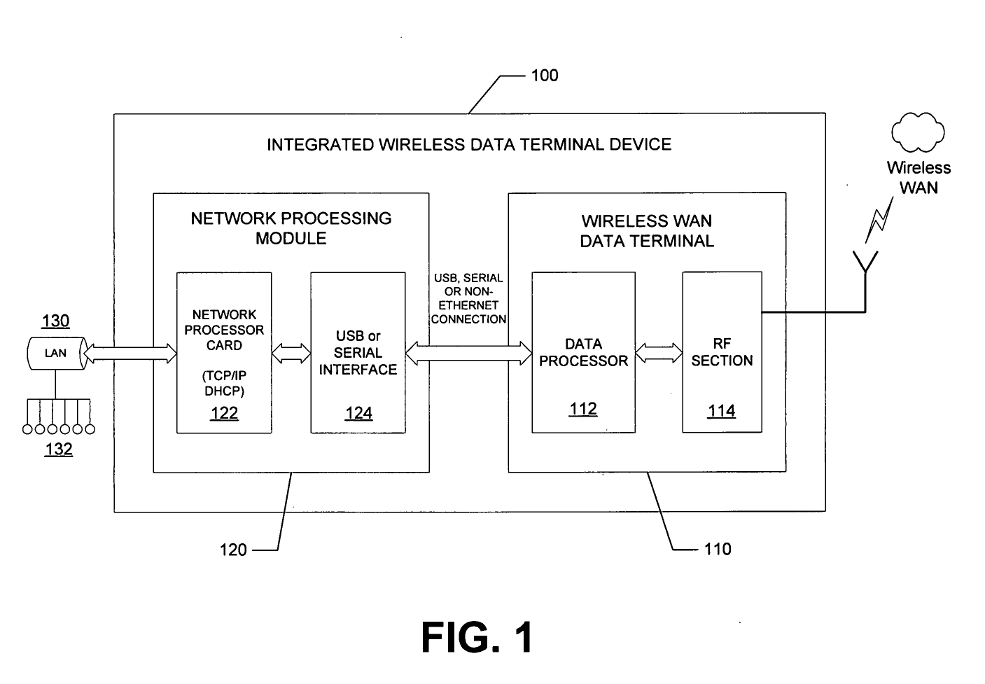

FIG. 1 illustrates one implementation of an integrated wireless data terminal device 100 configured to provide interface between a wireless wide-area network (WAN) data terminal 110 and a plurality of local-area network (LAN) devices 132. The integrated wireless data terminal device 100 includes the wireless WAN data terminal 110 and a network processing module 120 that provides an interface between the wireless WAN data terminal 110 and a plurality of LAN nodes 132 connected to a local-area network (LAN) 130.

The wireless WAN data terminal 110 includes a data processor 112, and an RF unit 114 that provide functions similar to existing functions provided by a conventional wireless WAN data terminal to enable communication over a wide-area network. The network processing module 120 includes a network processor card 122 and a USB or serial interface 124, which provides USB, serial, or other non-Ethernet connection between the wireless WAN data terminal 110 and the network processing module 120.

In one implementation, the network processing module 120 is an Ethernet module which provides transport protocol for the LAN 130 used in connecting the plurality of local-area network nodes 132, such as computers, printers, workstations, terminals, and other related devices within close physical proximity (e.g., within the same building). In accessing the local area network, an Ethernet connection is desirable since the Ethernet connection does not require the installation of any drivers and can support routed networks with ease. Therefore, by integrating the functionality of a network processing using Ethernet, multiple LAN devices can be connected to the wireless WAN data terminal.

Since local-area network (LAN) routers can connect a LAN to a WAN by interfacing a broadband WAN modem, such as the wireless WAN data terminal 110 shown in FIG. 1, the network processor card 122 is configured as a LAN router that functions as a host device to the wireless WAN data terminal 110. Furthermore, in such a configuration, interfaces such as a USB interface 124 enables integration of the Ethernet router and the wireless WAN data terminal 110 to provide a connectivity for the wireless WAN data terminal 110 to the LAN 130 through the integrated multi-port switch functionality of the router. This multi-port switch functionality of the network processor card 122 (e.g., implemented as an Ethernet router) enables connection of multiple LAN devices 132 to the wireless WAN data terminal 110. Further, as mentioned above, another advantage of integrating a network processor card 122, such as an Ethernet card, into the interface between the LAN 130 and the wireless WAN data terminal 110 instead of directly connecting the USB, serial, or PCMCIA interface 124 is the ease of setup.

To use interfaces, such as a USB, serial, or PCMCIA interface directly requires cumbersome installation and configuration of a device driver in the host computer. However, by using an Ethernet card with a built-in Dynamic Host Configuration Protocol (DHCP) server, configuration of host computers that use TCP/IP is automated. Thus, the DHCP server of the Ethernet card is used to automatically assign IP addresses, to deliver TCP/IP stack configuration parameters such as the subnet mask and default router, and to provide other configuration information such as the addresses for printer, time, and news servers.

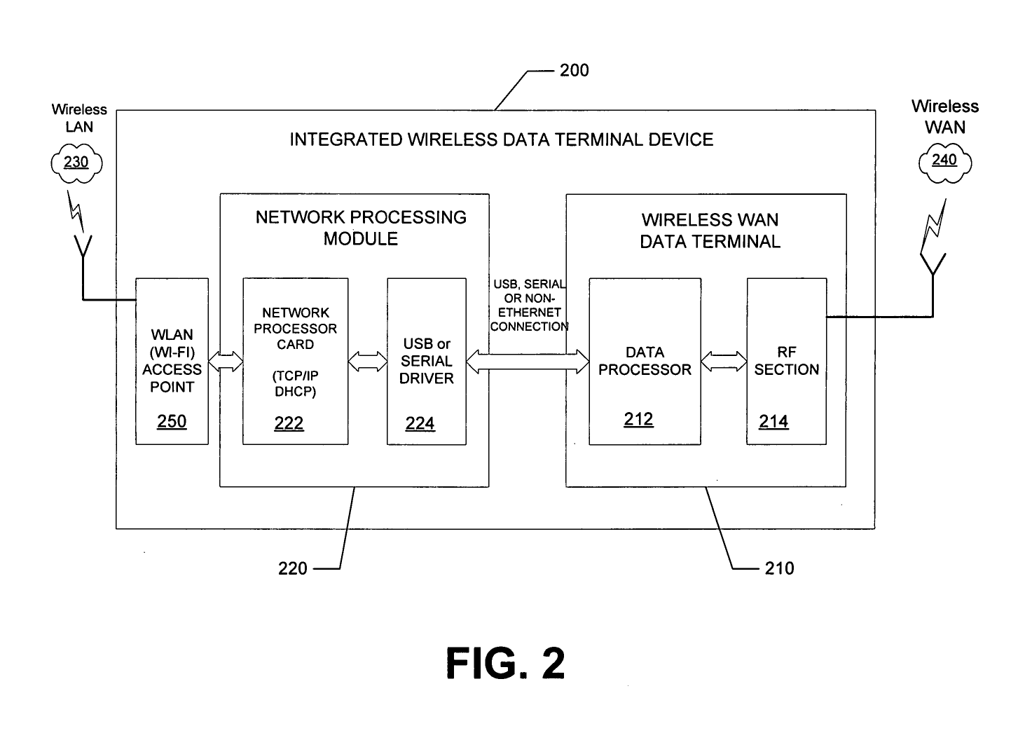

FIG. 2 illustrates another implementation of an integrated wireless data terminal device 200. Similar to the implementation of FIG. 1, the integrated wireless data terminal device 200 includes the wireless WAN data terminal 210 and a network processing module 220 that provides an interface between the wireless WAN data terminal 210 and a plurality of LAN nodes connected to a wireless LAN 230.

The wireless WAN data terminal 210 includes a data processor 212, and an RF unit 214 that provide functions similar to existing functions provided by a conventional wireless WAN data terminal to enable communication over a wide-area network. The network processing module 220 includes a network processor card 222 and a USB or serial interface 224, which provides USB, serial, or other non-Ethernet connection between the wireless WAN data terminal 210 and the network processing module 220.

In the illustrated implementation of FIG. 2, the wireless LAN 230 accessibility can be integrated into the router function of the network processor card 222 and an access point 250 to generate an instance wireless LAN, typically 802.11a, b, or g. Thus, instant LAN environment is generated by the built-in DHCP server and multi-port switch functionality. Data travels from a LAN-connected device in the wireless LAN 230 through the switch, the router, the USB connection, the wireless WAN data terminal, and to the wireless WAN 240. Data from the wireless WAN 240 to the LAN-connected device travels in the reverse sequence.

In one implementation, connectivity to the wireless WAN 240 is provided by telecommunication standards such as CDMA, GSM, or other related standards, and connectivity to the wireless LAN 230 is provided by Wi-Fi standard.

Various implementations of the invention are realized in electronic hardware, computer software, or combinations of these technologies. Most implementations include one or more computer programs executed by a programmable computer. For example, in one implementation, methods for providing interface between a wireless WAN data terminal and a plurality of LAN devices includes one or more computers executing software implementing the interface processes. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description provides several general examples for integrating a wireless WAN data terminal with a network processing module to enable interfacing with a plurality of LAN devices, other specific implementations are also contemplated.

In one specific implementation, the integrated wireless data terminal device is configured as a data-only fixed wireless broadband modem designed as a plug-and-play solution, with an Ethernet and USB connection module embedded in the modem. The fixed wireless broadband modem concept enables many users in developing countries that have multi-user, networked environments to connect to the Internet.

Accordingly, the present invention is not limited to only those implementations described above.

What is claimed is:

1. A wireless data terminal apparatus, comprising:
a wireless wide-area network (WAN) data terminal configured to provide data communication over a wireless wide-area telecommunication network, said wireless WAN data terminal including at least a data processor and an RF section; and
a network processing module configured to provide access to a local-area network (LAN), said network processing module providing multi-port switch functionality to allow connection of said wireless WAN data terminal to a plurality of LAN devices coupled to said LAN.

2. The apparatus of claim 1, wherein said network processing module is an Ethernet card.

3. The apparatus of claim 2, wherein said Ethernet card is configured as a router.

4. The apparatus of claim 2, wherein said Ethernet card includes a built-in DHCP server.

5. The apparatus of claim 1, further comprising
a USB interface coupled to said network processing module and said wireless WAN data terminal.

6. The apparatus of claim 1, wherein said wireless WAN data terminal is a broadband WAN modem for a laptop computer.

7. The apparatus of claim 1, further comprising
a wireless LAN access point to provide access to a wireless LAN.

8. A system comprising:
a local-area network (LAN) configured to network a plurality of nodes within a predefined distance of each other;
a wireless wide-area network (WAN) configured to provide a communication network for a plurality of wireless WAN data terminals; and
a wireless WAN data terminal apparatus operating to provide communication over said wireless WAN to said plurality of nodes in said LAN, said wireless WAN data terminal apparatus comprising:
a wireless WAN data terminal configured to provide data communication over a wireless wide-area telecommunication network, said wireless WAN data terminal including at least a data processor and an RF section; and
a network processing module configured to provide access to a local-area network (LAN), said network processing module providing multi-port switch functionality to allow connection of said wireless WAN data terminal to a plurality of LAN devices coupled to said LAN.

9. The system of claim 8, wherein said plurality of nodes includes computers, printers, workstations, and terminals.

10. The system of claim 8, wherein said network processing module is an Ethernet card.

11. The system of claim 10, wherein said Ethernet card is configured as a router.

12. The system of claim 10, wherein said Ethernet card includes a built-in DHCP server.

13. The system of claim 8, further comprising
a USB interface coupled to said network processing module and said wireless WAN data terminal.

14. The system of claim 8, wherein said wireless WAN data terminal is a broadband WAN modem for a laptop computer.

15. A method comprising:
configuring a wireless wide-area network (WAN) data terminal to provide data communication over a wireless wide-area telecommunication network, said wireless WAN data terminal including at least a data processor and an RF section; and
configuring a network processing module to provide access to a local-area network (LAN), said network processing module providing multi-port switch functionality to allow connection of said wireless WAN data terminal to a plurality of LAN devices coupled to said LAN.
